(19) United States
(12) Patent Application Publication
(10) Pub. No.: US 2023/0394297 A1
(43) Pub. Date: Dec. 7, 2023

(54) STATE LEARNING IN AN EVENT-SOURCED ARCHITECTURE FOR MATERIALS PROVENANCE (ESAMP)

(71) Applicant: TOYOTA RESEARCH INSTITUTE, INC., Los Altos, CA (US)

(72) Inventors: Jens Strabo HUMMELSHØJ, Millbrae, CA (US); Santosh K. SURAM, Mountain View, CA (US); Steven TORRISI, Berkeley, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 17/830,202

(22) Filed: Jun. 1, 2022

(51) Int. Cl. G06N 3/08

(52) U.S. Cl. CPC G06N 3/08

(57) ABSTRACT

A method for neural network material state prediction is described. The method includes encoding a sequence and interrelationships among events occurring in a simulation and/or experiment in an event-sourced architecture for materials provenance (ESAMP) framework. The method also includes learning an initial state of a material sample in the ESAMP framework. The method further includes sharing a state vector representing the initial state of the material sample with other material samples in the ESAMP framework. The method also includes learning how one or more processes affect the state of the material sample in the ESAMP framework according to the state vector shared with the other material samples in the ESAMP framework.

### TECHNICAL FIELD

Certain aspects of the present disclosure generally relate to artificial neural networks and, more particularly, to state learning in an event-sourced architecture for materials provenance (ESAMP).

### BACKGROUND

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

Machine learning may be used to perform both materials discovery and predict properties of the materials faster than molecular simulations. Machine learning can help identify correlations between material features and target properties. Nevertheless, it is challenging to learn how a state of a particular sample changes when the sample undergoes a particular process.

### SUMMARY

A method for neural network material state prediction is described. The method includes encoding a sequence and interrelationships among events occurring in a simulation and/or experiment in an event-sourced architecture for materials provenance (ESAMP) framework. The method also includes learning an initial state of a material sample in the ESAMP framework. The method further includes sharing a state vector representing the initial state of the material sample with other material samples in the ESAMP framework. The method also includes learning how one or more processes affect the state of the material sample in the ESAMP framework according to the state vector shared with the other material samples in the ESAMP framework.

A non-transitory computer-readable medium having program code recorded thereon for neural network material state prediction is described. The program code is executed by a processor. The non-transitory computer-readable medium includes program code to encode a sequence and interrelationships among events occurring in a simulation and/or experiment in an event-sourced architecture for materials provenance (ESAMP) framework. The non-transitory computer-readable medium also includes program code to learn an initial state of a material sample in the ESAMP framework. The non-transitory computer-readable medium further includes program code to share a state vector representing the initial state of the material sample with other material samples in the ESAMP framework. The non-transitory computer-readable medium also includes program code to learn how one or more processes affect the state of the material sample in the ESAMP framework according to the state vector shared with the other material samples in the ESAMP framework.

A system for neural network material state prediction described. The system includes a neural processing unit (NPU) and a memory coupled to the NPU. The system also includes instructions stored in the memory. When the instructions are executed by the NPU, the system is operable to encode a sequence and interrelationships among events occurring in a simulation and/or experiment in an event-sourced architecture for materials provenance (ESAMP) framework. The system is also operable to learn an initial state of a material sample in the ESAMP framework. The system is further operable to share a state vector representing the initial state of the material sample with other material samples in the ESAMP framework. The system is also operable to learn how one or more processes affect the state of the material sample in the ESAMP framework according to the state vector shared with the other material samples in the ESAMP framework.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-chip (SoC), including a general purpose processor, in accordance with certain aspects of the present disclosure.

FIGS. 2A, 2B, and 2C are diagrams illustrating a neural network, in accordance with aspects of the present disclosure.

FIG. 2D is a diagram illustrating a neural network, in accordance with aspects of the present disclosure.

FIG. 3 is a block diagram illustrating an overview of a sample process framework showing a central location of a sample process entity and a relationship of the sample process entity to the three major areas of the sample process framework, in accordance with aspects of the present disclosure.

FIGS. 4A-4C are block diagrams further illustrating the three major areas of the sample process framework as shown in FIG. 3, according to aspects of the present disclosure.

FIG. 5 is a block diagram illustrating a full graphical representation of a sample process framework, according to aspects of the present disclosure.

FIGS. 6A and 6B are block diagrams illustrating a sample state graph and state governing rules, according to aspects of the present disclosure.

FIG. 7 is a state diagram illustrating instantiation and evolution of a state Ψᵢ, as well as associated output prediction functions Fⱼ and associated output observables Oₖ, according to aspects of the present disclosure.

FIG. 8 is a flow diagram illustrating a method for neural network material state prediction, according to aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. Nevertheless, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

Machine learning is concerned with the automatic discovery of patterns in data through the use of computer algorithms. Once discovered, these patterns may be used to perform data classification and/or value prediction. With growing experimental and simulated dataset size for materials science research, the ability of algorithms to automatically learn and improve from data becomes increasingly useful. Various types of machine learning algorithms, such as neural networks, have recently been applied to materials research. Among these machine learning algorithms, convolutional neural networks (CNNs) have been very attractive in recent years due to their great success in image recognition.

A CNN may be composed of multilayer neural networks, of which at least one layer employs a mathematical operation called “convolution” to enable the CNN to extract high-level features directly from data. Compared to many other algorithms that specify or determine artificial features based on domain knowledge, a CNN involves relatively little pre-processing, as the features can be directly learned from the data. This is particularly useful when the features are difficult to exactly define. Unlike their long-used basic forms, such as perceptron and fully connected neural networks, CNNs are very recently used for solving solid state problems, such as learning material property prediction, material classification, and material phase transition identification.

Another advantage of neural networks is that they are easy to utilize in transfer learning, which means that a neural network first learns from a large database with inexpensive labels (e.g., first principles calculation results), and then it is fine-tuned on a small dataset where much fewer labeled samples are available (e.g., experimental data). This technique can be used to overcome the data scarcity problem in materials research, and it is applied to property prediction of small molecules and crystalline compounds very recently as a tool for accelerated materials discovery.

The practical realization and sustainable future of emergent technologies is dependent on accelerating materials discovery. Data-driven methods are anticipated to play an increasingly significant role in enabling this desired acceleration. While the vision of accelerating materials discovery using data-driven methods is well-founded, practical realization is throttled due to challenges in data generation, ingestion, and materials state-aware machine learning. High-throughput experiments and automated computational workflows are addressing the challenge of data generation, and capitalizing on these emerging data resources involves ingestion of data into an architecture that captures the complex provenance of experiments and simulations.

In computational materials science, these automated workflows produce large and diverse materials datasets. While these workflows and associated data management tools can be improved to facilitate capturing of a material's state and enable easy capture of reconfigurable analysis methods, their current implementations have facilitated a host of materials discoveries, emphasizing the importance of continued development of materials data architectures. In case of experimental materials science, the majority of the data remains in human readable format and is not ingested into a database, which helps improve a readability of the data. In cases where the databases exist, they are either large with limited scope or are diverse, but have limited data. This has limited application of machine learning for acceleration of experimental materials discovery to specific datasets.

Some aspects of the present disclosure are directed to learning how a state of a particular sample changes when the sample undergoes a particular process. In some aspects of the present disclosure, the samples are stored as experimental materials science data in a data structure, such as an event-sourced architecture for materials provenance (ESAMP) data structure. The ESAMP data structure may be a database architecture designed to store experimental materials science data. For example the ESAMP database may be configured to capture: (1) information about the samples in the database including storing provenance regarding how the material samples were created and what processes the material have undergone; (2) raw data from processes run on the material samples; and (3) information derived from analyses of the raw data.

Some aspects of the present disclosure learn the initial state of a particular sample that is stored as experimental materials science data in a database, such as the ESAMP database. At the outset, a neural network model may learn the initial state of a particular material sample. Additionally, a state vector that represents the initial state of a particular material sample may be shared across the board with other similar material samples if there is reason to believe that the material sample may have the same initial state. Then, the neural network model learns how a particular process changes the state of a particular material sample. This process continues and may utilize observables to train the neural network model. In the end, the neural network model predicts how a particular process changes the state of a particular material. Some aspects of the present disclosure integrate sample provenance information regarding how they were created and what processes they have undergone and learn what they share and where they are different.

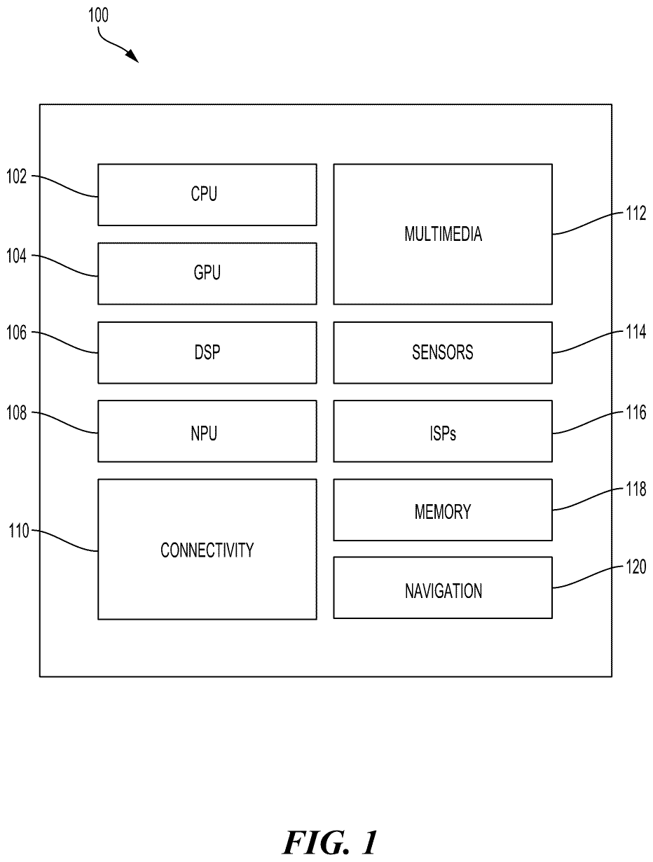

FIG. 1 illustrates an example implementation of a system-on-chip (SoC) 100, which may include a central processing unit (CPU) 102 or multi-core CPUs, in accordance with certain aspects of the present disclosure, such an artificial intelligence (AI) material state prediction. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a connectivity block 110, which may include fifth generation (5G) new radio (NR) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SoC 100 may also include a sensor processor 114 to provide sensor image data, image signal processors (ISPs) 116, and/or navigation module 120, which may include a global positioning system.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through automatic training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

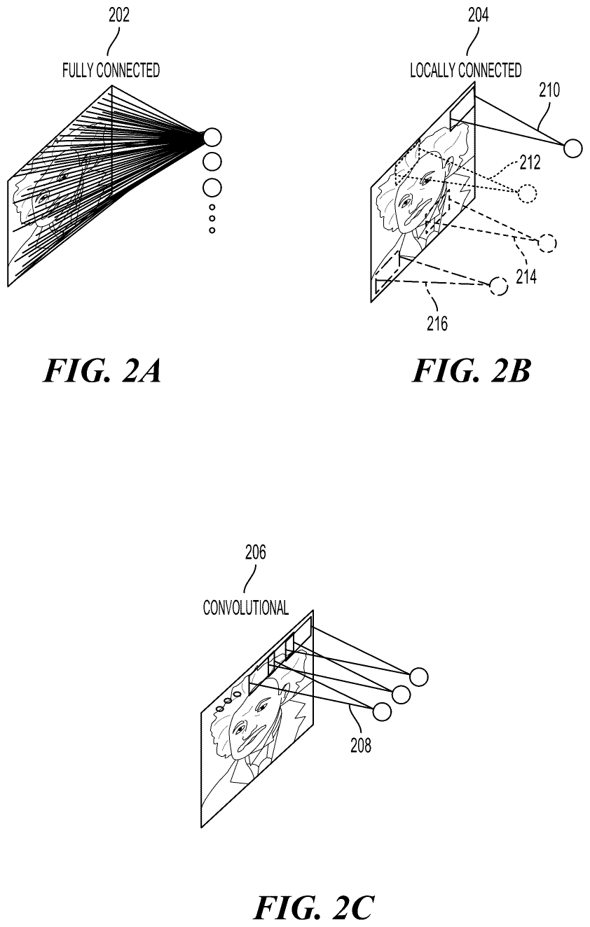

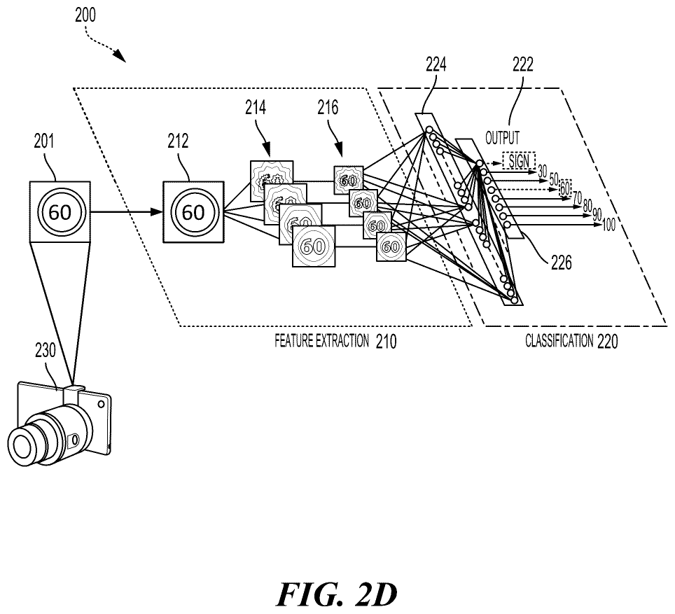

FIGS. 2A, 2B, and 2C are diagrams illustrating a neural network, in accordance with aspects of the present disclosure. The connections between layers of the neural network shown in FIG. 2A-2C may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer.

FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connection strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

FIG. 2C illustrates an example of a locally connected neural network is a convolutional neural network. As shown in FIG. 2C, an example of a locally connected neural network is provided as a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

FIG. 2D illustrates one type of convolutional neural network, referred to as a deep convolutional network (DCN). In particular, FIG. 2D illustrates a detailed example of a DCN 200 designed to recognize visual features from an image 201, which is provided as an input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights, or predicting states of material sample following processing.

The DCN 200 may be trained with supervised learning. During training, the DCN 200 may be presented with an image, such as the image 201 of a speed limit sign, and a forward pass may then be computed to produce an output 222. The DCN 200 may include a feature extraction section 210 and a classification section 220. Upon receiving the image 201, a convolutional layer 212 may apply convolutional kernels (not shown) to the image 201 to generate a first set of feature maps 214. As an example, the convolutional kernel for the convolutional layer 212 may be a 5×5 kernel that generates 28×28 feature maps. In the present example, because four different convolutional kernels were applied to the image 201 at the convolutional layer 212, four different feature maps are generated in the first set of feature maps 214. The convolutional kernels may also be referred to as filters or convolutional filters.

The first set of feature maps 214 may be subsampled by a max pooling layer (not shown) to generate a second set of feature maps 216. The max pooling layer reduces the size of the first set of feature maps 214. That is, a size of the second set of feature maps 216, such as 14×14, is less than the size of the first set of feature maps 214, such as 28×28. The reduced size provides similar information to a subsequent layer while reducing memory consumption. The second set of feature maps 216 may be further convolved via one or more subsequent convolutional layers (not shown) to generate one or more subsequent sets of feature maps (not shown).

In the example of FIG. 2D, the second set of feature maps 216 is convolved to generate a first feature vector 224. Furthermore, the first feature vector 224 is further convolved to generate a second feature vector 226. Each feature of the second feature vector 226 may include a number that corresponds to a possible feature of the image 201, such as “sign,” “60,” and “100.” A softmax function (not shown) may convert the numbers in the second feature vector 226 to a probability. As such, an output 222 of the DCN 200 is a probability of the image 201 including one or more features.

In the present example, the probabilities in the output 222 for “sign” and “60” are higher than the probabilities of the others of the output 222, such as “30,” “40,” “50,” “70,” “80,” “90,” and “100.” Before training, the output 222 produced by the DCN 200 is likely to be incorrect. Thus, an error may be calculated between the output 222 and a target output. The target output is the ground truth of the image 201 (e.g., “sign” and “60”). The weights of the DCN 200 may then be adjusted so the output 222 of the DCN 200 is more closely aligned with the target output.

As shown in FIGS. 2A-2D, machine learning is concerned with the automatic discovery of patterns in data through the use of computer algorithms. Once discovered, these patterns may be used to perform data classification and/or value prediction. With growing experimental and simulated dataset size for materials science research, the ability of algorithms to automatically learn and improve from data becomes increasingly useful. Various types of machine learning algorithms, such as neural networks, have recently been applied to materials research. Among these machine learning algorithms, convolutional neural networks (CNNs) have been very attractive in recent years due to their great success in image recognition.

The DCN 200 shown in FIG. 2D is composed of multilayer neural networks, of which at least one layer employs a mathematical operation called “convolution” to enable the DCN 200 to extract high-level features directly from data. Compared to many other algorithms that specify artificial features based on domain knowledge, the DCN 200 involves relatively little pre-processing, as the features can be directly learned from the data, such as the image 201. This is particularly useful when the features are difficult to exactly define. Unlike their long-used basic forms, such as perceptrons and fully connected neural networks, DCNs are very recently used for solving solid state problems, such as learning material property prediction, material classification, and material phase transition identification.

Another advantage of neural networks is that they are easy to utilize in transfer learning, which means that a neural network first learns from a large database with inexpensive labels (e.g., first principles calculation results), and then it is fine-tuned on a small dataset where much fewer labeled samples are available (e.g., experimental data). This technique can be used to overcome the data scarcity problem in materials research, and it is applied to property prediction of small molecules and crystalline compounds very recently as a tool for accelerated materials discovery.

The practical realization and sustainable future of emergent technologies is dependent on accelerating materials discovery using neural networks. Data-driven methods are anticipated to play an increasingly significant role in enabling this desired acceleration. While the vision of accelerating materials discovery using data-driven methods is well-founded, practical realization is throttled due to challenges in data generation, ingestion, and materials state-aware machine learning. High-throughput experiments and automated computational workflows are addressing the challenge of data generation, and capitalizing on these emerging data resources involves ingestion of data into an architecture that captures the complex provenance of experiments and simulations.

In computational materials science, these automated workflows produce large and diverse materials datasets. While these workflows and associated data management tools can be improved to facilitate capturing of a material's state and enable easy capture of reconfigurable analysis methods, their current implementations have facilitated a host of materials discoveries, emphasizing the importance of continued development of materials data architectures. In case of experimental materials science, the majority of the data remains in human readable format and is not ingested into a database. In cases where the databases exist, they are either large with limited scope or are diverse, but have limited data. This has limited application of machine learning for acceleration of experimental materials discovery to specific datasets.

Some aspects of the present disclosure are directed to learning how a state of a particular sample changes when the sample undergoes a particular process. In some aspects of the present disclosure, the samples are stored as experimental materials science data in a database, such as an event-sourced architecture for materials provenance (ESAMP) database. The ESAMP database is a database architecture designed to store experimental materials science data. For example the ESAMP database may be configured to capture: (1) information about the samples in the database including storing provenance regarding how they were created and what processes they have undergone, (2) raw data from processes run on the samples, and (3) information derived from analyses of these raw data.

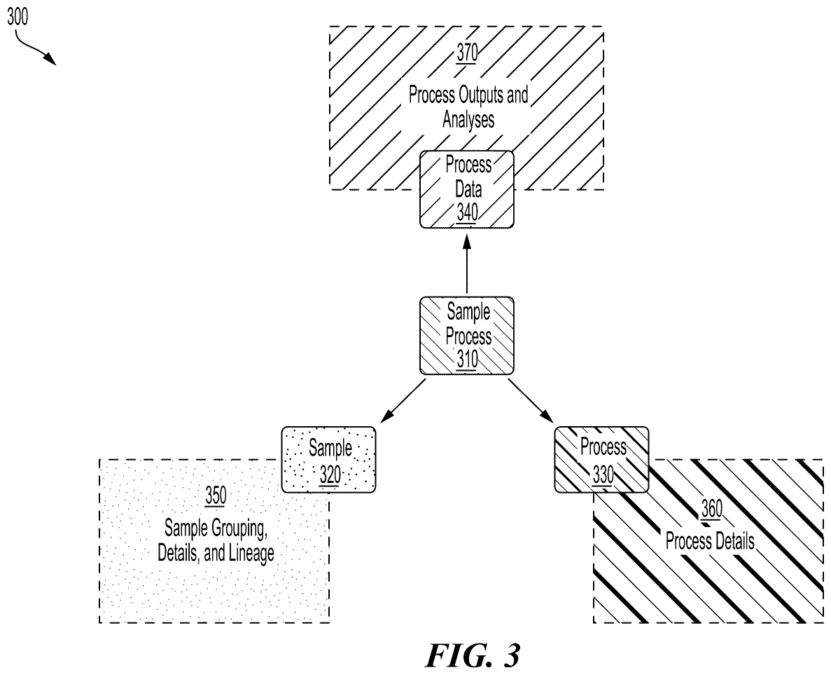

Some aspects of the present disclosure learn the initial state of a particular sample that is stored as experimental materials science data in a database, such as the ESAMP database. At the outset, a neural network model may learn the initial state of a particular material sample. Additionally, a state vector that represents the initial state of a particular material sample may be shared across the board with other similar material samples if there is reason to believe that the material sample may have the same initial state. Then, the neural network model learns how a particular process changes the state of a particular material sample. This process continues and may utilize observables to train the neural network model. In the end, the neural network model predicts how a particular process changes the state of a particular material. Some aspects of the present disclosure integrate sample provenance information regarding how they were created and what processes they have undergone and learn what they share and where they are different, for example, as shown in FIG. 3.

FIG. 3 is a block diagram illustrating an overview of a sample process framework showing a central location of a sample process entity 310 and a relationship of the sample process entity 310 to the three major areas of the sample process framework 300, in accordance with aspects of the present disclosure. In some aspects of the present disclosure, the three major areas of the sample process framework 300 include a sample 320, a process 330, and process data 340. The sample process framework 300 may first track the state of samples and instruments involved in a laboratory to completely capture the ground truth. In this example, the focus is mainly on the state of samples, and it is noted that the sample process framework 300 could capture the state of instruments or other research entities.

In some aspects of the present disclosure, the sample process framework 300 enables tracking of a sample provenance by considering three entities: the sample 320, the process 330, and the process data 340. These three entities may be designed to provide intuitive ingestion of data from both traditional manual experiments and their automated or robotic analogues.

In this example, the sample 320 is a label that specifies a physically-identifiable representation of an entity that can undergo many processes (e.g., the liquid in that vial or the thin film on that substrate). An assumption placed on the sample 320 is that the sample 320 has a unique identity for enabling tracking of a lineage and a process history of the sample process entity 310. Samples can be combined or split to form complex lineages. For example, samples such as an anode and a cathode may be joined in a battery or a vial of precursor used in multiple catalyst preparations.

Another area of the sample process framework 300 is the process 330. As described, the process 330 is an event that occurs to one or more samples. For example, the process 330 is associated with an experiment in a laboratory, such as annealing in a sample furnace or performing spectroscopic characterization. In addition, processes have input parameters and are identified by the machine (or human) that performed the process at a specific time.

A further area of the sample process framework 300 is the process data 340. As described, the process data 340 is data generated by a process 330 that applies to one or more of the sample 320 that underwent the process 330. Because the process 330 but not the process data 340 is central to sample provenance, management of the process data 340 can occur in a connected but distinct part of the sample process framework 300. As many raw outputs from scientific processes are difficult to interpret without many additional steps of analysis, the process data 340 is connected to a section of the framework devoted to iterative steps of analysis where the process data 340 is transformed and combined to form a higher-level figure of merit (FOM).

According to some aspects of the present disclosure, the sample 320, the process 330, and the process data 340 entities are connected via the sample process entity 310 (e.g., a table) to form a central structure of the sample process framework 300. In some aspects of the present disclosure, the sample 320, the process 330, and the process data 340 are tables, having associated secondary tables. In this example, the secondary tables support the central tables of the sample 320, the process 330, and the process data 340. For example, a sample secondary table 350 stores sample details, a process secondary table 360 stores process details, a process data secondary table 370 stores process outputs and analyses. A description of each region is further expanded upon below.

As shown in FIG. 3, the trinity of the sample 320, the process 330, and the process data 340 enable the sample process framework 300 to capture the ground truth associated with any given sample in an experimental dataset. Nevertheless, interpretation of experimental data involves completely capturing the provenance of the sample 320. That is, throughout the lifetime of the sample 320, tracking the following three questions is performed: (1) how was the sample created; (2) what processes occurred to the sample; and (3) if the sample no longer exists, how was the sample consumed? The second question is directly answered by the sequence of entries in the sample process entity 310 (e.g., table), in which each record in the sample process entity 310 includes the time that a sample underwent a process. Nevertheless, this concept is complicated by processes that merge, split, or otherwise alter physical identification of samples. Such processes are often responsible for the creation and consumption of samples. For example the deposition of a catalyst onto an electrode or the use of the same precursor in many different molecule formulations are often responsible for the creation and consumption of samples.

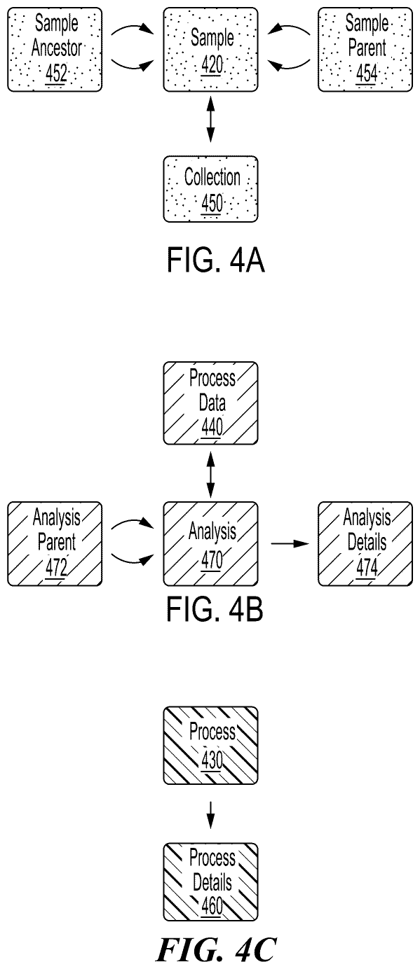

FIGS. 4A-4C are block diagrams further illustrating the three major areas of the sample process framework 300 as shown in FIG. 3, according to aspects of the present disclosure. FIG. 4A is a block diagram illustrating potentially-complex lineages of a sample 420 that are tracked through a sample ancestor entity 452 and a sample parent entity 454, based on a collection 450 of the sample 420. For example, the process history of the “parent” catalyst or precursor is an inherent part of the provenance of the “child” catalyst electrode or molecular material, which may be tracked using the tables shown in FIG. 4A.

Both the sample ancestor entity 452 and the sample parent entity 454 are defined by their connection to two sample entities, indicating a parent/ancestor and child/descendant relationship, respectively. The sample parent entity 454 indicates that the child sample was created from the sample parent entity 454 and should inherit its process history lineage. Each can be decorated with additional attributes to indicate its role in the parent-child relationship, such as labeling the anode and cathode when creating a battery. The sample ancestor entity 452 is nearly identical to the sample parent entity 454 with an additional attribute called “rank” that indicates the number of generations between the ancestor and the descendant. A rank of 0 indicates a parent-child relationship, while a rank of 2 indicates a great-grandparent type relationship. These two entities can capture the complex lineages produced by experimental workflows.

The final entity connected to the sample 420 is the collection 450. It is common for researchers to group samples. For example, in high throughput experiments many samples may exist on the same chip or plate, or researchers may include in a collection all samples synthesized for a single project. In these cases, researchers keep track of and make queries based on this information. It is clear from the previously-mentioned example that many samples may belong to at least one of the collection 450. In addition, the sample 420 exists in many of the collections of the sample secondary table 350. For example, a researcher may want to group samples by which plate or wafer they are on, which high-level project they are a part of, and which account they should be billed to all at the same time. The corresponding many-to-many relationships are supported by an ESAMP data structure.

FIG. 4C is a block diagram further illustrating the processes and process details of the process 330 of the sample process framework 300 of FIG. 3, according to aspects of the present disclosure. A process 430 represents one experimental procedure (e.g., a synthesis or characterization) that is applied to a sample (e.g., the sample 420 of FIG. 4A). The one specification imposed on the process 430 is the ability to chronologically sort the process 430. Chronological sorting is desired for accurately representing a sample's process history. Therefore, each of the process 430 is uniquely associated with a timestamp and machine/user. There is an underlying assumption that for a single process time and a given machine/user, a sole process is occurring, although that process may involve multiple samples.

While single-step experiments on machine-based workflows can easily provide a precise timestamp for each of the process 430, it is cumbersome and error-prone for researchers to provide these at the timescale of seconds or even hours. Additionally, some multi-step processes may reuse the initial timestamp throughout each step, associating an initiation timestamp with a closely-coupled series of experiments whose ordering is known but whose individual time stamps are not tracked. It is important to add a simple ordering parameter to represent the chronology when the time stamp alone is insufficient for tracking manual experiments. In particular, this ordering parameter allows researchers to record the date and a counter for the number of experiments they have completed that day. In multi-step processes, each step can be associated with an index to record the order of steps.

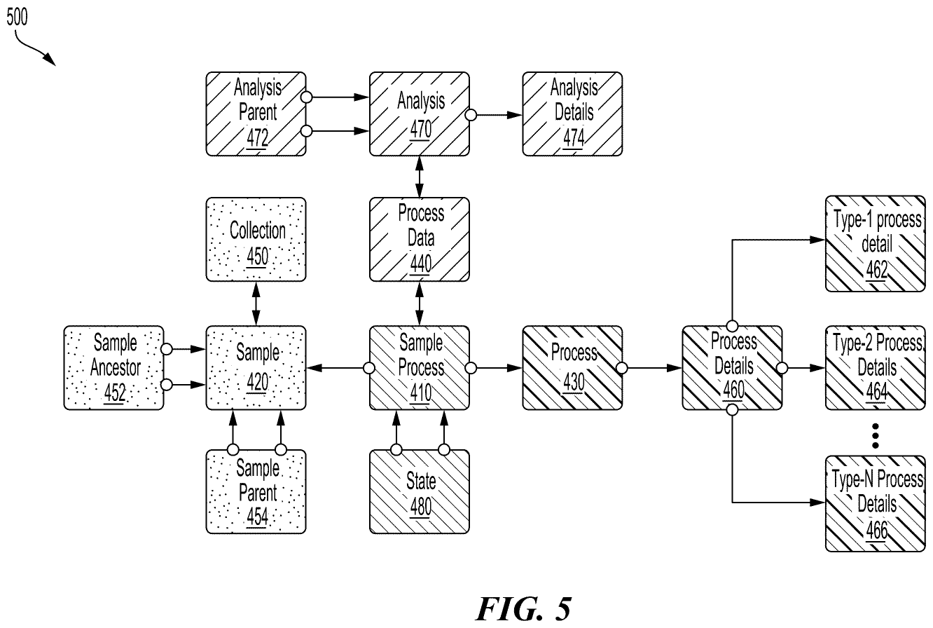

As described, processes indicate that an experimental event has occurred to one or more samples. Nevertheless, the process details entity 460 tracks information describing the type of process that occurred and the process parameters used or any information involved in reproducing the experiment. For example, a given research workflow may be composed of many different types of experiments (e.g., electrochemical, XPS, or deposition processes). Each of these types of processes is also associated with a set of input parameters. The process details entity 460 and its associated process-specific tables are used to track metadata for each of the process 430. A more comprehensive discussion on the representation of process details for various relational database management system (RDMS) implementations is provided in FIG. 5.

FIG. 4B is a block diagram further illustrating the process data and analysis of the process data 340 of the sample process framework 300 of FIG. 3, according to aspects of the present disclosure. While the collection 450 tracks sample inputs to the process 430, a process data 440 block tracks the output of the process 430. For reproducibility, transparency, and ability to continue experiments without reliance on an active database connection, it is prudent to store process outputs as raw files independent from the data management provided by the sample process framework 300. Therefore, while the process data 440 may include relevant data parsed from the raw files, the process data 440 should also include a raw file path.

Additionally, attributes can be added to specify the location to search for the file such as cloud storage or a local storage drive. A single file may also contain multiple pieces of data that each refers to different samples. This complexity motivates the inclusion of the start and end line numbers for a file identifying information for the process data 440. If an entire file is to be consumed as a single piece of the process data 440, null values can be provided for those attributes. As a significant amount of scientific data is stored as comma-separated values (CSV) files, it can also be beneficial to parse these file directly into values in a database. For example, database storage of this data may be performed using flexible column data types. For large datasets, storing data using efficient binary serializations may be beneficial.

The relationship between process outputs and their associated processes and samples can be complex. The most straightforward relationship is one piece of the process data 440 that is generated for a single sample, which is typically the case for serial experimentation and traditional experimentation performed without automation. In parallel experimentation, however, a single process involves many samples, and if the resulting data is relevant to all samples, the process data 440 has a many-to-one relationship to the samples. In multi-model experiments, multiple detectors can generate multiple pieces of data for a single sample in a single process, where the single sample has a one-to-many relationship with the process data. Parallel, multi-model experimentation can result in many-to-many relationships. To model these different types of experimentation in a uniform manner, ESAMP manages many-to-many relationships between processes and their associated process outputs.

The raw output of scientific processes may involve several iterative analytical steps before the desired results can be obtained. In some aspects of the present disclosure, the sample process framework 300 is designed for tracking the full provenance of scientific data. Enabling tracking of the full provenance of scientific data, involves tracking the lineage of the analytical steps, similarly to that of samples and processes. As shown in FIG. 4B, lineage tracking is achieved by using an analysis table 470, an analysis details table 474, and an analysis parent 472. The analysis table 470 may represent a single analytical step and, similar to the process 430, is identified by inputs, outputs, and associated parameters. Just as the collection 450 has a many-to-many relationship with the sample 420, the analysis table 470 has a many-to-many relationship with the process data table. For example, a piece of process data can be used as an input to multiple analyses and a single analysis can have multiple pieces of process data as inputs. The type of analysis and its input parameters are stored in the analysis details table 474. The analysis type should define the analytical transformation function applied to the inputs, while the parameters are fed into the function alongside the data inputs.

An important difference between the analysis table 470 and the analysis details table 474 is that the analysis table 470 can use the output of multiple ones of the process data 440 and analysis parent 472 entities as inputs. This is analogous to the parent-child relationship as that modeled by the sample ancestor entity 452 and the sample parent entity 454. The introduction of analysis parent 472 (e.g., table) allows for this complex lineage to be modeled. This allows for even the most complex analytical outputs to be traced back to the raw entities and the intermediate analyses on which they are based.

FIG. 5 is a block diagram illustrating a full graphical representation of a sample process framework 500, according to aspects of the present disclosure. The sample process framework 500 provides a complete illustration of the sample process framework 300 of FIG. 3, including the three major areas of the sample process framework 300 shown in FIGS. 4A-4C, according to aspects of the present disclosure. In some aspects of the present disclosure, single-headed arrows between the blocks of the sample process framework 500 indicate a many-to-one relationship in the direction of the arrow. In addition, double-headed arrows indicate a many-to-many relationship. In some aspects of the present disclosure, a database implementation of the sample process framework 500 is defined using standard entity relationship language. In one implementation, the sample process framework 500 is instantiated in a relational database management system (RDMS), but is not tied to a specific implementation.

In this example, the sample process framework 500 expands on the process 430 and the process details entity 460 blocks shown in FIG. 4C as the process 330 of the sample process framework 300 of FIG. 3. As shown, the process details entity 460 is expanded to illustrate process type details, such as a type-1 process details 462, a type-2 process details 464, and a type-N process details 466. In addition, the sample process framework 500 adds a state 480 to the sample process 410. In practice, during experiments the sample 420 of the sample process framework 500 may be intentionally or unintentionally altered based on a state change. For example, a researcher could measure the composition of the sample 420, perform an electrochemical process (as tracked by the sample process 410) that unknowingly changes the composition, in which a final process performs a spectroscopic characterization. Even though the label of the sample 420 is preserved throughout these three processes, directly associating the composition measurement with the spectroscopic measurement can lead to incorrect analysis because the intervening process altered the link between the first process and the final process.

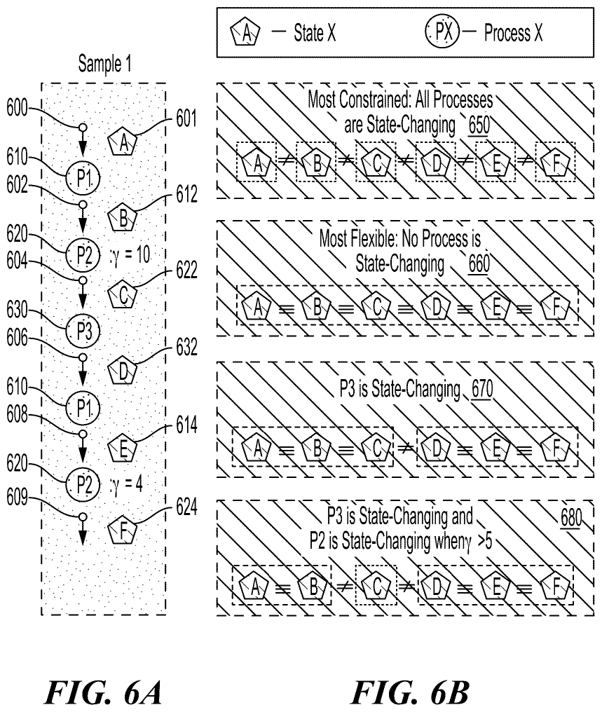

This example motivates the desire for the final entity in the sample process framework 500 of FIG. 5; namely, the state 480. In some aspects of the present disclosure, an ESAMP model for the state 480 assumes that each of the sample process 410 irreversibly changes the sample 420. As shown in the sample process framework 500, the state 480 is defined by two entities of the sample process 410 that share the sample 420 and do not have an entity of the sample process 410 chronologically between the two entities of the sample process 410. By managing the state 480 under the most conservative assumption that every process alters the sample's state, any state equivalency rules (SERs), (e.g., whether a certain type of process alters the state or not) may be applied in a transparent manner. A new state table (e.g., the state 480) may be constructed from these SERs, which may be easily modified either by a human or a machine. This state tracking process is further illustrated in FIGS. 6A and 6B.

FIGS. 6A and 6B are block diagrams illustrating a sample state graph and state governing rules, according to aspects of the present disclosure. In this example, a first sample 600 (e.g., Sample 1) is shown undergoing five processes: a process P1 610, a process P2 620, and a process P3 630, in which the process P1 610 and the process P2 620 are repeated after the process P3 630. In addition, a state is defined between every process, and prior to applying a first process to a sample. For example, an initial state A 601 is the state of the first sample 600 prior to application of the first process P1 610 to the first sample 600. A state B 612 is the state of the first sample 600 after application of the process P1 610. Similarly, state C 622 is the state of the second sample 602 after application of the process P2 620. In addition, a state D 632 is the state of a third sample 604 after application of the process P3 630. Also, a state E 614 is the state of the fourth sample 606 after application of the process P1 610. Similarly, state F 624 is the state of the fifth sample 608 after application of the process P2 620 to generate a final sample 609, having the state F 624.

In some aspects of the present disclosure, a state essentially provides a link between the input and output of a process. For example, the state B 612 provides a link between the input (e.g., the first sample 600) and the output (e.g., a second sample 602) of the process P1 610. As described, a process may be state-changing or the process may be non-state-changing, such that an equivalency between the states occurs in response to the process. For example, if the process P1 610 is a state-changing process, the state B 612 is not equivalent to the state A 601, and the first sample 600 is not equivalent to the second sample 602. By contrast, if the process P1 610 is a non-state-changing process, the state B 612 is equivalent to the state A 601, and the first sample 600 is equivalent to the second sample 602.

FIG. 6B illustrates different sets of process governing rules, according to aspect of the present disclosure. The right boxes show how different sets of rules govern whether a process is state-changing or non-state-changing in the equivalency between the states. Without any rules, all processes are assumed to be state-changing, and no states are equivalent. For example, a first box 650 specifies a most constrained rule, in which all processes are state-changing, such that the states are non-equivalent (e.g., A≠B≠C≠D≠E≠F). This constraint can be fully relaxed to make all states equivalent, as shown in the second box 660 (e.g., A≡B≡C≡D≡E≡F). This constraint can also be partially relaxed based on process type or process details. For example, as shown in the third box 670, process P3 630 is state-changing based on a certain condition (e.g., A≡B≡C≠D≡E≡F). As shown in the fourth box 680, process P3 630 is state-changing, and process P2 620 is state-changing based on another condition of γ>5 (e.g., A≡B≠C≠D≡E≡F).

FIG. 6A shows an example of a state graph of a first sample 600 (e.g., Sample 1). In this example, the first sample 600 undergoes a series of five processes (e.g., P1 610, P2 620, P3 630, P1 610, and P2 620) that involve three distinct types of processes. In addition, a new state (e.g., state A 601, state B 612, state C 622, state D 632, state E 614, and state F 624) is created after each process. If no relaxation assumptions are applied, processes P1 610, P2 620, and P3 630 are assumed to be state-changing, and because all states (e.g., state A 601, state B 612, state C 622, state D 632, state E 614, and state F 624) are non-equivalent, it might be invalid to share process data or derived analysis amongst the first sample 600, the second sample 602, the third sample 604, the fourth sample 606, the fifth sample 608, and the final sample 609.

Under the most relaxed constraint as shown in the second box 660 of FIG. 6B, no processes are state-changing. Nevertheless, the utility of the state is the ability to apply a domain and use-specific rules to model state equivalent rules (SERs). For example, consider the process P3 630 to be a destructive electrochemical experiment (as shown in the third box 670 of FIG. 6B) that changes the sample's composition, while the other processes are innocuous characterization experiments. By designating the process P3 630 as state-changing, the first sample 600 can be considered to have two unique states (e.g., (A=B=C)≠(D=E=F)). SERs can be further parameterized by utilizing simple rules of the process to determine state-changing behavior. For example, if process P2 620 is an anneal step, the process P2 620 is considered as a state-changing process if the temperature rises above a certain level. By defining simple rules, merging equivalent states yields simpler state graphs that serve as the basis for dataset curation. This powerful concept of state is enabled by the core ability of the sample process framework 500 of FIG. 5 to track the process provenance of samples throughout their lifetime.

Some aspects of the present disclosure learn the initial state of a particular sample that is stored as experimental materials science data in a database, such as an ESAMP database, according to the sample process framework 500 shown in FIG. 5. At the outset, a neural network model may learn the initial state of a particular material sample. Additionally, a state vector (e.g., state A 601, state B 612, state C 622, state D 632, state E 614, and/or state F 624) that represents the initial state of a particular material sample (e.g., Sample 1) may be shared across the board with other similar material samples if there is reason to believe that the material sample may have the same initial state. Next, the neural network model learns how a particular process changes the state of a particular material sample. This process continues and may utilize observables to train the neural network model. In the end, the neural network model predicts how a particular process (e.g., processes P1 610, P2 620, and P3 630) changes the state of a particular material (e.g., the first sample 600). Some aspects of the present disclosure integrate sample provenance information regarding how they were created and what processes they have undergone and learn what they share and where they are different.

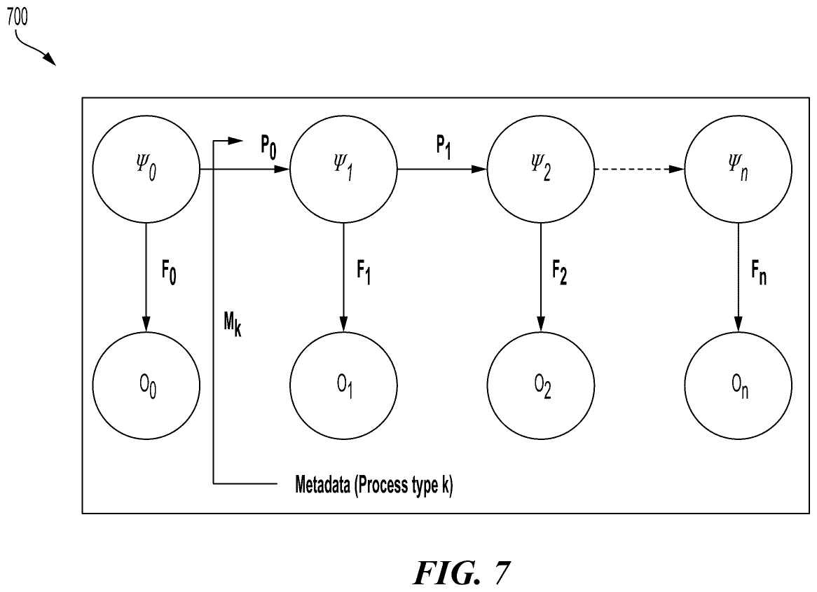

FIG. 7 is a state diagram 700 illustrating instantiation and evolution of a state Ψᵢ, as well as associated output prediction functions Fⱼ and associated output observables Oₖ, according to aspects of the present disclosure. As described, a material sample has an associated state that evolves in time. Events that may or may not modify the state of a material sample are referred to as processes. The full set of processes that act upon a material sample up to a given point in time are referred to as a process provenance of the material sample.

Some aspects of the present disclosure instantiate a state vector (Ψ) describing the state of a material sample. This instantiation can occur either at random, or using an ‘embedding function’ E that creates the state vector based upon some prior information about the material sample. As described, the full set of data available up to the time of creation of the material sample is denoted as X, and subsequently available data is referred to as Xᵢ. An embedding function using all available data at an initial time of interest (e.g., denoted as i=0) would thus take the form E(X₀)=Ψ₀.

In some aspects of the present disclosure, an embedding is updated by a process function P which acts upon the state vector Ψ at a particular time i (e.g., Ψᵢ) using available data Xᵢ to update this state vector Ψᵢ to a next state, P(Xᵢ,Ψᵢ)=Ψᵢ₊₁. In this example, the process function P may vary with time, and is denoted as Pᵢ. In some aspects of the present disclosure tracking the evolution of the state of a material sample is used to predict an output observable property of interest at a particular time, Oⱼ. A separate output prediction function is defined (and may vary), Fₖ, that maps from the state of a material sample to an output observable property (e.g., Fₖ(Ψᵢ)=Oⱼ). It should be recognized that a target observable property's location in time may not be the same time as the state of the material sample; namely, i≠j or i=j. For example, an early prediction may be performed in which the observable property is associated with some future time.

As shown in FIG. 7, an initial state vector Ψ_{O} is shown, in which an initial output prediction function Fₖ may be applied to the initial state vector Ψ₀ to provide an initial observable property O₀ of an initial material sample. The initial state vector Ψ₀ tracks the application of an initial process function P₀ to the initial material sample in a first state vector Ψ₁. A next output prediction function F₁ may be applied to the next state vector Ψ₁ to provide a next observable property O₁ of a next material sample. This process may share the state vector Ψ with other related materials, which may be analyzed using the output prediction function F to provide observable state properties O to enable learning how the process functions P affect the state of material samples. These aspects of the present disclosure allow for metadata, M, (e.g., process type k) to be considered by the process function P for learning how processes affect the state of the material sample in the ESAMP structure, for example, as shown in FIG. 5.

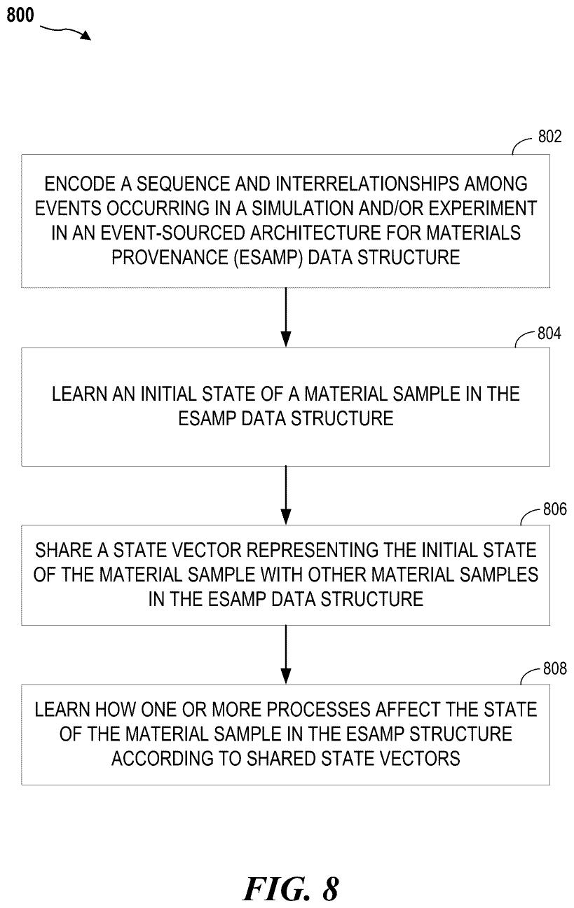

In some aspects of the present disclosure, the associated state vector Ψᵢ of the material samples, as well as associated output prediction functions Fⱼ and associated output observables Oₖ is shared with other material samples. Learning of these various parameters associated with the state vector Ψᵢ is performed by sharing the state vector Ψᵢ with the other related material samples. This sharing of the state vector Ψᵢ with the other related material samples enables learning how one or more processes affect the state of the material sample in the ESAMP structure according to the observable properties of the shared state vectors Ψᵢ, as shown in FIG. 7. This process is further illustrated, for example, according to a method as shown in FIG. 8.

FIG. 8 is a flow diagram illustrating a method for neural network material state prediction, according to aspects of the present disclosure. A method 800 begins at block 802, in which encoding a sequence and interrelationships among events occurring in a simulation and/or experiment in an event-sourced architecture for materials provenance (ESAMP) data structure. For example, FIG. 5 shows a full graphical representation of a sample process framework 500, according to aspects of the present disclosure. The sample process framework 500 provides a complete illustration of the sample process framework 300 of FIG. 3, including the three major areas of the sample process framework 300 shown in FIGS. 4A-4C, according to aspects of the present disclosure.

At block 804, an initial state of a material sample in the ESAMP data structure is learned. For example, as shown in the sample process framework 500 of FIG. 5, the state 480 is defined by two entities of the sample process 410 that share the sample 420 and do not have an entity of the sample process 410 chronologically between the two entities of the sample process 410. By managing the state 480 under the most conservative assumption that every process alters the sample's state, any state equivalency rules (SERs), (e.g., whether a certain type of process alters the state or not) may be applied in a transparent manner. A new state table (e.g., the state 480) may be constructed from these SERs, which may be easily modified either by a human or a machine. This state tracking process is further illustrated in FIGS. 6A and 6B.

At block 806, a state vector representing the initial state of the material sample is shared with other material samples in the ESAMP data structure. For example, as shown in FIG. 7, a state vector (Ψ) describing the state of a material sample is instantiated. This instantiation can occur either at random, or using an ‘embedding function’ E that creates the state vector based upon some prior information about the material sample. As described, the full set of data available up to the time of creation of the material sample is denoted as X, and subsequently available data is referred to as Xᵢ. An embedding function using all available data at an initial time of interest (e.g., denoted as i=0) would thus take the form E(X₀)=Ψ₀. In some aspects of the present disclosure tracking the evolution of the state of a material sample is used to predict an output observable property of interest at a particular time, Oⱼ. A separate output prediction function is defined (and may vary), Fₖ, that maps from the state of a material sample to an output observable property (e.g., Fₖ(Ψᵢ)=Oⱼ).

At block 808, how one or more processes affect the state of the material sample in the ESAMP structure are learned according to shared state vectors. For example, as shown in FIG. 7, after sharing the state vector Ψ with other related materials, the shared state vector Ψ may be analyzed using the output prediction function F to provide observable state properties O to enable learning how the process functions P affect the state of material samples. These aspects of the present disclosure allow for metadata, M, (e.g., process type k) to be considered by the process function P for learning how processes affect the state of the material sample in the ESAMP structure, for example, as shown in FIG. 5. Learning of these various parameters associated with the state vector Ψᵢ is performed by sharing the state vector Ψᵢ with the other related material samples. This sharing of the state vector Ψᵢ with the other related material samples enables learning how one or more processes affect the state of the material sample in the ESAMP structure according to the observable properties of the shared state vectors Ψᵢ, as shown in FIG. 7.

The method 800 also includes integrating provenance information regarding how material samples are created and what processes the material samples have undergone. The method 800 also includes learning shared and different characteristics of the material samples based on the integrated provenance information. The method 800 further includes predicting a state change of a material sample as the material sample undergoes a selected process. The method 800 further includes training a neural network to predict a state change of a material sample after the material sample undergoes a selected process. The method 800 also includes training a neural network to predict the state change of each material sample having a shared initial state vector. The method 800 also includes sharing the state vector representing the initial state of the material sample with other material samples in the ESAMP framework for each material sample having a same initial state.

The method 800 also includes encoding by assembling an ESAMP database, and storing, in the ESAMP database, provenance information regarding creation of material samples and processes undergone by each of the material samples. The method 800 further includes encoding by storing, in the ESAMP database, raw process data from processes run on the material samples. The method 800 also includes analyzing of the stored raw process data to derive state information from the stored raw process data. The method 800 also includes encoding by storing, in the ESAMP database, the derived state information regarding the processes run on the material samples, for example, as shown in FIGS. 5-7.

In some aspects, the method 800 may be performed by the SoC 100 (FIG. 1). That is, each of the elements of the method 800 may, for example, but without limitation, be performed by the SoC 100 or one or more processors (e.g., CPU 102 and/or NPU 108) and/or other components included therein.

The system for accelerating machine learning includes means for dynamically routing inference between the sub-neural networks of a neural network acceleration architecture. In one aspect, the routing means may be the switch device 302 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed, include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein, may be downloaded and/or otherwise obtained by a user terminal and/or base station as applicable. For example, such a device can be coupled to a server to facilitate the transfer of means for performing the methods described herein. Alternatively, various methods described herein, may be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for neural network material state prediction, comprising:
encoding a sequence and interrelationships among events occurring in a simulation and/or experiment in an event-sourced architecture for materials provenance (ESAMP) framework;
learning an initial state of a material sample in the ESAMP framework;
sharing a state vector representing the initial state of the material sample with other material samples in the ESAMP framework; and
learning how one or more processes affect the state of the material sample in the ESAMP framework according to the state vector shared with the other material samples in the ESAMP framework.

2. The method of claim 1, further comprising:
integrating provenance information regarding how the material samples are created and what processes the material samples have undergone; and
learning shared and different characteristics of the material samples based on the integrated provenance information.

3. The method of claim 1, further comprising predicting a state change of a material sample as a selected process is applied to the material sample.

4. The method of claim 1, further comprising training a neural network to predict a state change of a material sample after a selected process is applied to the material sample.

5. The method of claim 4, in which the neural network is trained to predict the state change of each of the material samples having a shared initial state vector.

6. The method of claim 1, in which sharing the state vector representing the initial state of the material sample with the other material samples in the ESAMP framework is performed for each of the material samples having the initial state.

7. The method of claim 1, in which encoding further comprises:
assembling an ESAMP database;
storing, in the ESAMP database, provenance information regarding creation of the material samples and processes undergone by each of the material samples.

8. The method of claim 7, in which encoding further comprises:
storing, in the ESAMP database, raw process data from processes run on the material samples;
analyzing of the raw process data from the ESAMP database to derive a state information of the raw process data from the ESAMP database; and
storing, in the ESAMP database, the state information regarding the processes run on the material samples.

9. A non-transitory computer-readable medium having program code recorded thereon for neural network material state prediction, the program code being executed by a processor and comprising:
program code to encode a sequence and interrelationships among events occurring in a simulation and/or experiment in an event-sourced architecture for materials provenance (ESAMP) framework;
program code to learn an initial state of a material sample in the ESAMP framework;
program code to share a state vector representing the initial state of the material sample with other material samples in the ESAMP framework; and
program code to learn how one or more processes affect the state of the material sample in the ESAMP framework according to the state vector shared with the other material samples in the ESAMP framework.

10. The non-transitory computer-readable medium of claim 9, further comprising:
program code to integrate a provenance information regarding how the material samples are created and what processes the material samples have undergone; and
program code to learn shared and different characteristics of the material samples based on the integrated provenance information.

11. The non-transitory computer-readable medium of claim 9, further comprising program code to predict a state change of a material sample as a selected process is applied to the material sample.

12. The non-transitory computer-readable medium of claim 9, further comprising program code to train the neural network to predict a state change of a material sample after a selected process is applied to the material sample.

13. The non-transitory computer-readable medium of claim 12, in which the program code to train the neural network further comprises program code to predict the state change of each of the material samples having a shared initial state vector.

14. The non-transitory computer-readable medium of claim 9, in which the program code to share the state vector representing the initial state of the material sample with the other material samples in the ESAMP framework is performed for each of the material samples having the initial state.

15. The non-transitory computer-readable medium of claim 9, in which the program code to encode further comprises:
program code to assemble an ESAMP database;
program code to store, in the ESAMP database, provenance information regarding creation of the material samples and processes undergone by each of the material samples.

16. The non-transitory computer-readable medium of claim 15, in which the program code to encode further comprises:
program code to store, in the ESAMP database, raw process data from processes run on the material samples;
program code to analyze the raw process data from the ESAMP database to derive a state information of the raw process data from the ESAMP database; and
program code to store, in the ESAMP database, the state information regarding the processes run on the material samples.

17. A system for neural network material state prediction, the system comprising:
a neural processing unit (NPU);
a memory coupled to the NPU, and instructions stored in the memory and operable, when executed by the NPU, cause the system:
to encode a sequence and interrelationships among events occurring in a simulation and/or experiment in an event-sourced architecture for materials provenance (ESAMP) framework;
to learn an initial state of a material sample in the ESAMP framework;
to share a state vector representing the initial state of the material sample with other material samples in the ESAMP framework; and
to learn how one or more processes affect the state of the material sample in the ESAMP framework according to the state vector shared with the other material samples in the ESAMP framework.

18. The system of claim 17, in which the instructions further cause the system:
to integrate a provenance information regarding how the material samples are created and what processes the material samples have undergone; and
to learn shared and different characteristics of the material samples based on the integrated provenance information.

19. The system of claim 17, in which the instructions further cause the system to predict a state change of a material sample as a selected process is applied to the material sample.

20. The system of claim 17, in which the instructions further cause the system to train the neural network to predict a state change of a material sample after a selected process is applied to the material sample.
